(19) United States
(12) Patent Application Publication
(10) Pub. No.: US 2006/0136212 A1
(43) Pub. Date: Jun. 22, 2006

(54) Method and apparatus for improving text-to-speech performance

(75) Inventors: Ruiqiang Zhuang, Coral Springs, FL (US); Jyh-Han Lin, Parkland, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/022,488

(22) Filed: Dec. 22, 2004

(51) Int. Cl. G10L 13/08

(52) U.S. Cl. 704/260

(57) ABSTRACT

In a device (100), a method (200) is provided for improving text-to-speech performance. The method includes the steps of determining (202) if a text expression from an application operating in the device is in a vocabulary, selecting (204) a corresponding speech expression from the vocabulary if the text expression is included therein, synthesizing (206) the text expression into a corresponding speech expression if the text expression is not in the vocabulary, playing (208) said speech expression audibly from the device, monitoring (210) a frequency of use of said text expression, storing (212) said text expression and corresponding speech expression in the vocabulary if the frequency of use of said expression is greater than a predetermined threshold and said expressions were not previously stored, eliminating (214) one or more text expressions and corresponding speech expressions from the vocabulary if the frequency of use of said expressions falls below the predetermined threshold, and repeating the foregoing steps during operation of the application. An apparatus implementing the method is also included.

### FIELD OF THE INVENTION

This invention relates generally to text-to-speech synthesizers, and more particularly to a method and apparatus for improving text-to-speech performance.

### BACKGROUND OF THE INVENTION

Synthesizing text-to-speech (TTS) is MIPS (Million Instructions Per Second) intensive. In battery-operated devices, resources such as a microprocessor and accompanying memory may not always be available to provide a consistent performance when synthesizing TTS, especially when such resources are concurrently being used by other software applications. Consequently, the performance of synthesizing TTS can sound choppy or unintelligible to a user with a device having limited resources. Moreover, frequent synthesis of TTS can drain battery life.

The embodiments of the invention described below help to overcome this limitation in the art.

### SUMMARY OF THE INVENTION

Embodiments in accordance with the invention provide a method and apparatus for improving text-to-speech (TTS) performance.

In a first embodiment of the present invention, a device provides a method for improving text-to-speech performance. The method includes the steps of synthesizing a vocabulary of frequently used text expressions into speech expressions, storing the speech expressions in the vocabulary, determining if a text expression from an application operating in the device is in the vocabulary, selecting a corresponding speech expression from the vocabulary if the text expression is included therein, synthesizing the text expression into a speech expression if the text expression is not in the vocabulary, playing the speech expression audibly from the device, and repeating the foregoing steps starting from the determining step during operation of the application.

In a second embodiment of the present invention, a device provides a method for improving text-to-speech performance. The method includes the steps of determining if a text expression from an application operating in the device is in a vocabulary, selecting a corresponding speech expression from the vocabulary if the text expression is included therein, synthesizing the text expression into a corresponding speech expression if the text expression is not in the vocabulary, playing said corresponding speech expression audibly from the device, monitoring a frequency of use of said text expression, storing the text expression and the corresponding speech expression in the vocabulary if the frequency of use of said expression is greater than a predetermined threshold and said expressions were not previously stored, eliminating one or more text expressions and corresponding speech expressions from the vocabulary if the frequency of use of said expressions falls below the predetermined threshold, and repeating the foregoing steps during operation of the application.

In a third embodiment of the present invention, a device comprising an audio system, a memory, and a processor coupled to the foregoing elements. The processor is programmed to determine if a text expression from an application operating in the device is in a vocabulary, selecting a corresponding speech expression from the vocabulary if the text expression is included therein, synthesize the text expression into a corresponding speech expression if the text expression is not in the vocabulary, play said corresponding speech expression audibly from the audio system, monitor a frequency of use of said text expression, store in the memory a vocabulary of said text expression and corresponding speech expression if the frequency of use of said expressions is greater than a predetermined threshold, eliminate from the vocabulary one or more text expressions and corresponding speech expressions if the frequency of use of said expressions falls below the predetermined threshold, and repeat the foregoing steps during operation of the application.

### BRIEF DESCRIPTION OF THE DRAWINGS

FIG. 1 is a block diagram of a device for improving text-to-speech (TTS) performance

FIG. 2 is a flow chart illustrating a method operating on the device of FIG.

### DETAILED DESCRIPTION OF THE DRAWINGS

While the specification concludes with claims defining the features of embodiments of the invention that are regarded as novel, it is believed that the embodiment of the invention will be better understood from a consideration of the following description in conjunction with the figures, in which like reference numerals are carried forward.

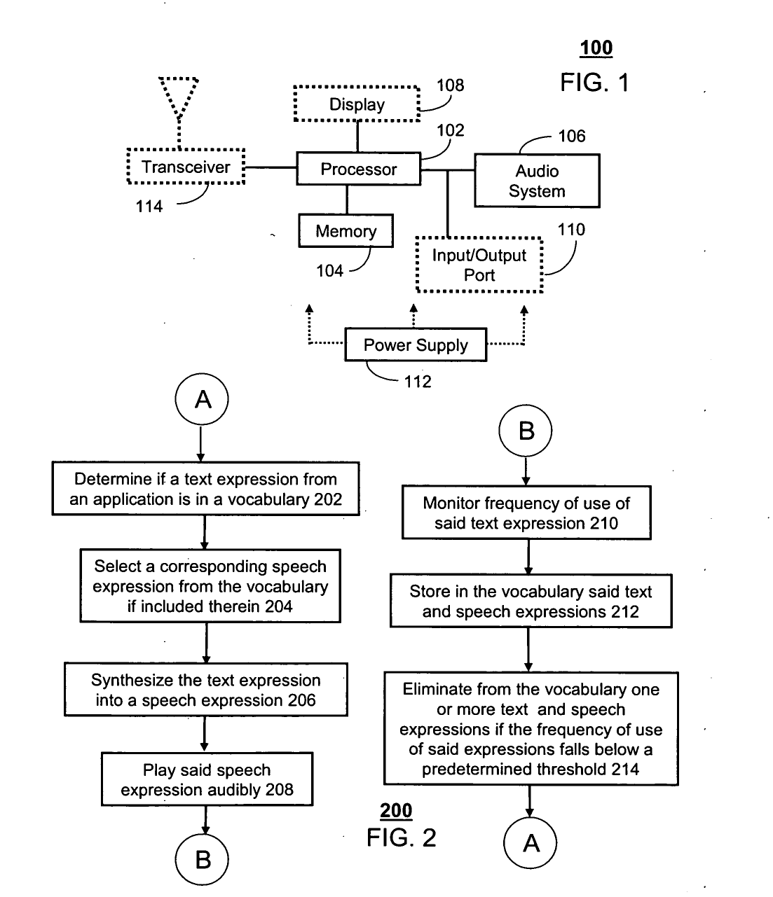

FIG. 1 is an illustration of a device 100 for improving text-to-speech (TTS) performance In a first embodiment, the device 100 includes a processor 102, a memory 104, an audio system 106 and a power supply 112. In supplemental embodiment, the device 100 further includes a display 108, an input/output port 110, and a wireless transceiver 114. Each of the components 102-114 of the device 100 utilizes conventional technology as will be explained below.

The processor 102, for example, comprises a conventional microprocessor, a DSP (Digital Signal Processor), or like computing technology singly or in combination to operate software applications that control the components 102-114 of the device 100 in accordance with the invention. The memory 104 is a conventional memory device for storing software applications and for processing data therein. The audio system 106 is a conventional audio device for processing and presenting to an end user of the device 100 audio signals such as music or speech. The power supply 112 utilizes conventional supply technology for powering the components 102-1 14 of the device 100. Where the device is portable, the power supply 112 utilizes batteries coupled to conventional circuitry to supply power to the device 100.

In more sophisticated applications, the device 100 can utilize a transceiver 114 to communicate wirelessly to other devices via a conventional communication system such as a cellular network. Moreover, the device 100 can utilize a display 108 for presenting a UI (User Interface) for manipulating operations of the device 100 by way of a conventional keypad with navigation functions coupled to the input/output port 110.

FIG. 2 is a flow chart illustrating a method 200 operating on the device 100 of FIG. 1. The method 200 begins with step 202 where the processor 102 is programmed to determine if a text expression from an application operating in the processor 102 is in a vocabulary stored in the memory 104.

The application can be any conventional software application that utilizes TTS (Text-To-Speech) synthesis in the normal course of operation. A conventional J2ME (Java 2 platform Micro Edition) application is an example of such an application. Generally, J2ME applications consist of a JAR (Java ARchive) file containing class and resource files and an application descriptor file. The application descriptor file can include a vocabulary of frequently used text expressions, or such a vocabulary can be managed in a separate file referred to herein as a VDF (Vocabulary Descriptor File). Maintaining the vocabulary in a file separate from the application descriptor file provides the end user of the device 100 or the enterprise supplying the J2ME application the flexibility to customize and update the vocabulary independent of the application. Moreover, the VDF can be made available to more than one J2ME application operating on the processor 102.

The VDF can consist of an application name, an application JAR file, an application version, and application vocabulary list. The vocabulary list consists of expressions consisting of words and/or short phrases used frequently by the application. The expressions in the vocabulary can be formatted using SSML (Speech Synthesis Markup Language) which provides the capability to control aspects of speech such as pronunciation, volume, pitch, and rate, just to name a few.

Prior to operating the application, the method 200 can be supplemented by pre-loading the application with a VDF containing a predetermined vocabulary of frequently used expressions. In this embodiment, the determining step 202 is preceded with a step (not shown in FIG. 2) in which the vocabulary containing the frequently used text expressions is synthesized into corresponding speech expressions. The vocabulary comprising these expressions is then stored in the memory 104 utilizing a conventional database technology. To execute the synthesis step, the processor 102 can utilize any conventional TTS engine for generating a conventional compact speech format such as AMR or VSELP.

Referring back to method 200, after the determining step the processor 102 selects in step 204 a corresponding speech expression from the vocabulary in the VDF if the text expression is included therein. If not, the text expression of the J2ME application is synthesized in step 206 by the conventional TTS engine mentioned above. In step 208, the processor 102 directs the audio system 106 to play the corresponding speech expression. In step 210, the processor 102 monitors a frequency of use of the text expression, and stores in the memory 104, in step 212, the text expression and corresponding speech expression if the frequency of use is greater than a predetermined threshold and said expressions were not previously stored in the memory 104.

In step 214, the processor 102 eliminates from the memory 104 one or more text expressions and corresponding speech expressions from the vocabulary if the frequency of use of said expressions falls below the predetermined threshold. Execution of step 214 can be dependent on whether additional room is needed in the memory 104 as a consequence of the preceding storage steps.

The storage and elimination steps 212-214 follow a conventional database technique for efficiently storing and retrieving said text and speech expressions to and from the memory 104. Additionally, the end user of the device 100 or the supplier of the J2ME application can elect the value of the predetermined threshold according to, for example, the nature of application, or some other relevant operating factor.

To enhance TTS performance, the processor 102 continues to repeat the foregoing steps starting from the determination step 202 during operation of the J2ME application. In addition, to capture historical patterns of frequently used expressions, the processor 102 can apply conventional caching techniques to the memory 104, to enhance TTS performance by reducing the incidence of synthesis steps, increase the speed of storage and retrievals, which together improve the battery life of the device 100.

The method 200 can be further supplemented with, for example, a periodic update of one or more vocabularies of frequently used expressions supplied by the enterprise providing the J2ME application. The vocabularies can be received through the input port 110 (e.g., coupled to the Internet with a conventional modem), or can be received over-the-air by way of the wireless transceiver 114. When these vocabularies are received, the text expressions are synthesized by the processor 102 to generate corresponding speech expressions. The vocabulary in the memory 104 is then updated with the foregoing expressions. When additional vocabularies and/or updated vocabularies are received and synthesized, the processor 102 may call on step 214 to make room in the memory 104 if there is insufficient room for these new expressions. The updated vocabularies can help to enhance the end user experience and battery life of the device 100 as fewer synthesis steps are required.

In light of the foregoing description, it should be recognized that embodiments in the present invention could be realized in hardware, software, or a combination of hardware and software. These embodiments could also be realized in numerous configurations contemplated to be within the scope and spirit of the claims below. It should also be understood that the claims are intended to cover the structures described herein as performing the recited function and not only structural equivalents.

For example, although wired communications and wireless communications may not be structural equivalents in that wired communications employ a physical means for communicating between devices (e.g., copper or optical cables), while wireless communications employ radio signals for communicating between devices, a wired communication system and a wireless communication system achieve the same result and thereby provide equivalent structures. Accordingly, equivalent structures that read on the description are intended to be included within the scope of the invention as defined in the following claims.

What is claimed is:

1. In a device, a method for improving text-to-speech performance, comprising the steps of:
synthesizing a vocabulary of frequently used text expressions into corresponding speech expressions;
storing the corresponding speech expressions in the vocabulary;
determining if a text expression from an application operating in the device is in the vocabulary;
selecting a corresponding speech expression from the vocabulary if the text expression is included therein;
synthesizing the text expression into a corresponding speech expression if the text expression is not in the vocabulary;
playing the corresponding speech expression audibly from the device; and
repeating the foregoing steps starting from the determining step during operation of the application.

2. The method of claim 1, further comprising the step of storing the text expression and the corresponding speech expression in the vocabulary if the frequency of use of said expression is greater than a predetermined threshold and said expressions were not previously stored.

3. The method of claim 2, further comprising the step of eliminating one or more text expressions and corresponding speech expressions from the vocabulary if the frequency of use of said expressions fall below the predetermined threshold.

4. The method of claim 3, wherein the storing and eliminating steps follow a caching technique for managing storage in the device.

5. The method of claim 3, wherein the storing and eliminating steps follow a database technique for managing storage in the device.

6. The method of claim 3, wherein execution of the eliminating step depends on whether additional storage room is required for the storing step.

7. The method of claim 1, further comprising the steps of:
receiving one or more vocabulary updates of frequently used text expressions from a source coupled to the device;
synthesizing said text expressions into corresponding speech expressions; and
updating the vocabulary with said text and corresponding speech expressions.

8. The method of claim 1, further comprising the step of sharing the vocabulary among a plurality of applications operating in the device.

9. In a device, a method for improving text-to-speech performance, comprising the steps of:
determining if a text expression from an application operating in the device is in a vocabulary;
selecting a corresponding speech expression from the vocabulary if the text expression is included therein;
synthesizing the text expression into a corresponding speech expression if the text expression is not in the vocabulary;
playing the corresponding speech expression audibly from the device;
monitoring a frequency of use of the text expression;
storing the text expression and the corresponding speech expression in the vocabulary if the frequency of use of said expression is greater than a predetermined threshold and said expressions were not previously stored;
eliminating one or more text expressions and corresponding speech expressions from the vocabulary if the frequency of use of said expressions falls below the predetermined threshold; and
repeating the foregoing steps during operation of the application.

10. The method of claim 9, wherein the storing and eliminating steps follow a caching technique for managing storage in the device.

11. The method of claim 9, wherein the storing and eliminating steps follow a database technique for managing storage in the device.

12. The method of claim 9, further comprising the steps of:
receiving one or more vocabularies of frequently used text expressions from -a source coupled to the device;
synthesizing said text expressions into corresponding speech expressions; and
updating the vocabulary with said text and corresponding speech expressions.

13. The method of claim 9, further comprising the step of sharing the vocabulary among a plurality of applications operating in the device.

14. The method of claim 9, wherein execution of the eliminating step depends on whether additional storage room is required for the storing step.

15. A device, comprising:
an audio system;
a memory; and
a processor coupled to the foregoing elements, wherein the processor is programmed to:
determine if a text expression from an application operating in the device is in a vocabulary;
select a corresponding speech expression from the vocabulary if the text expression is included therein;
synthesize the text expression into a corresponding speech expression if said text expression is not in the vocabulary;
play said corresponding speech expression audibly from the device;
monitor a frequency of use of said text expression;
store the text expression and the corresponding speech expression in the vocabulary if the frequency of use of said expression is greater than a predetermined threshold and said expressions were not previously stored;
eliminate one or more text expressions and corresponding speech expressions from the vocabulary if the frequency of use of said expressions falls below the predetermined threshold; and
repeat the foregoing steps during operation of the application.

16. The device of claim 15, wherein the store and eliminate steps follow a caching technique for managing storage in the memory.

17. The device of claim 15, wherein the store and eliminate steps follow a database technique for managing storage in the memory.

18. The device of claim 15, wherein the device further includes an input port, and wherein the processor is further programmed to:
receive one or more vocabulary updates of frequently used text expressions from a source coupled to the input port;
synthesize said text expressions into corresponding speech expressions; and
update the vocabulary with said text and corresponding speech expressions.

19. The device of claim 15, wherein the processor is further programmed to share the vocabulary among a plurality of applications operating in the processor.

20. The device of claim 15, wherein execution of the eliminate step depends on whether additional room in the memory is required for the store step.
